(19) United States
(12) Patent Application Publication
(10) Pub. No.: US 2014/0025420 A1
(43) Pub. Date: Jan. 23, 2014

(54) SIMULTANEOUS MICRO SPACE AND ASSORTMENT OPTIMIZATION FOR PRODUCTS

(71) Applicant: Infosys Limited, Bangalore (IN)

(72) Inventors: Dinesh Govind Joshi, Thane (IN); Subhashis Nath, Bangalore (IN); Vinoop Aradhya, Bangalore (IN); Nagaraj Vijaya Kumar, Bangalore (IN); Mahesh Huyilalu Shivaram, Bangalore (IN); Anupam Kulshreshtha, Karnataka (IN)

(73) Assignee: Infosys Limited

(21) Appl. No.: 13/944,566

(22) Filed: Jul. 17, 2013

(30) Foreign Application Priority Data
Jul. 18, 2012 (IN) 3056/CHE/2012

(51) Int. Cl. G06Q 10/06

(52) U.S. Cl. CPC G06Q 10/06313
USPC 705/7.23

(57) ABSTRACT

Techniques and tools are described for determining optimal product assortments and optimal planograms using a hybrid binary multi-dimensional knapsack representation. An optimal product assortment and an optimal planogram can be determined by receiving one or more objectives, receiving one or more constraints, receiving dimensions and hierarchies, transforming the dimensions and hierarchies into structural graphs of s-cells, generating a dynamic model using, at least in part, the one or more objectives, performing an optimization run using the dynamic model, and outputting results of the optimization run. An optimal product assortment and an optimal planogram can also be determined by receiving product attributes for a set of products, receiving avatar information, receiving one or more objectives and constraints, generating a dynamic model using, performing an optimization run using the dynamic model, and outputting results of the optimization run.

### BACKGROUND

Simultaneous micro space, assortment, and resource planning can be used to determine product selection, placement, and arrangement in retail environments. However, existing solutions often involve manual, time-consuming processes and produce sub-optimal results.

Furthermore, existing solutions limit customization options. For example, some solutions only provide for selection from a number of pre-defined space plans. Using pre-defined space plans does not allow for custom planograms, specialized for clusters, stores, and seasons, which may provide better results. In addition, some solutions use pre-planned assortments of products and do not provide for custom assortments, which may be specialized for clusters, stores, and/or seasons. Other solutions provide for drawing planograms only as a manual process.

Therefore, there exists ample opportunity for improvement in technologies related to simultaneous micro space, assortment, and/or resource optimization.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and tools are described for determining optimal product assortments and optimal planograms. For example, optimization can be performed using a dynamic model uses a hybrid binary multi-dimensional knapsack representation.

For example, a method is provided for determining an optimal set of products to be carried for a product assortment and an optimal planogram using a hybrid binary multi-dimensional knapsack representation. The method comprises receiving one or more objectives, receiving one or more constraints, receiving dimensions and hierarchies, transforming the dimensions and hierarchies into structural graphs of s-cells, generating a dynamic model using, at least in part, the one or more objectives (e.g., revenue, profit, rank, etc.), performing an optimization run using the dynamic model, and outputting results of the optimization run.

As another example, a method is provided for determining an optimal product assortment and an optimal planogram. The method comprises receiving product attributes for a set of products, receiving avatar information for the set of products, receiving one or more objectives (which can include, for example, revenue, profit, rank, etc.), receiving one or more constraints, generating a dynamic model using, at least in part, the one or more objectives, where the dynamic model uses a hybrid binary multi-dimensional knapsack representation, performing an optimization run using the dynamic model, and outputting results of the optimization run, where the results comprise an optimal planogram for an optimal product assortment, and where the optimal product assortment is selected from the set of products. The results can also comprise financial reports, space reports, and/or inventory reports for the optimal planogram.

The foregoing and other objects, features, and advantages of the invention will become more apparent from the following detailed description, which proceeds with reference to the accompanying figures.

### BRIEF DESCRIPTION OF THE DRAWINGS

FIG. 1 is a flowchart showing an example method for determining an optimal set of products to be carried for a product assortment and an optimal planogram.

FIG. 2 is a flowchart showing an example method for determining an optimal product assortment and an optimal planogram.

FIG. 3 is a diagram depicting an example planogram representing an optimal product assortment with a fixed number of facings.

FIG. 4 is a diagram depicting an example planogram representing an optimal product assortment with a variable number of facings.

FIG. 5 is a diagram depicting an example planogram, including avatar products.

FIG. 6 is a block diagram illustrating an example mobile computing device in conjunction with which techniques and tools described herein may be implemented.

### DETAILED DESCRIPTION

The following description is directed to techniques and solutions for optimizing product assortments and generating optimal planograms. For example, product assortment can be optimized based on rank, profit, and/or revenue criteria. The product assortment (e.g., a collection of products from which products of the product assortment are selected) can be selected for placement on a shelf or shelving unit of a store/store cluster and/or for a particular season. Various assumptions, approximations, relaxations, and/or constraints can be applied to facilitate optimization operations. One or more models can be used to perform optimization (e.g. using one or more optimization runs) where the models use, at least in part, a hybrid binary multi-dimensional knapsack representation.

Optimization of product assortments and planograms can also be performed using, at least in part, avatar products. For example, a quantity and/or variation (e.g., rotation, stacking, facing) of the same product (or different products) can be grouped as an avatar product. The avatar product can then be optimized (e.g., as a single product entity) separately or in combination with other products and/or avatar products. Avatar products can be used, for example, to group products based on criteria such as cluster/store, season, demographics, geographic location, types of fixtures, etc.

The techniques and solutions described herein can be applied to optimize product assortments and planograms. For example, one or more of the following approaches and advantages can be realized using the techniques and solutions described herein:
The technologies described herein can provide an approach to find an optimal set of products to be carried in an assortment and an optimal planogram for a typical retail store and/or store cluster, at a micro level for one or many seasons or independent of season.
The technologies described herein can propose a best possible location for the selected assortment (e.g., taking into account specific constraints, relaxations, approximations, and/or assumptions).
The technologies described herein can provide an approach to accommodate various constraints on a flexible case-by-case basis.
The technologies described herein can provide a way to assess the impact of varying product margins on a potential product assortment for a potential planogram targeting different fixtures associated with store/cluster for that category/sub-category and for one or many seasons or independent of season.
The technologies described herein can provide an easy approach to deciding upon a number of facings to be carried by the retailers in case elasticity (e.g., variation in sales due to variations in facings) is to be considered.
The technologies described herein can also be used to derive useful space elasticity substitutes in computing an optimal solution macro (e.g., department or category) levels.

### Example Assumptions

In the techniques and solutions described herein, one or more of the following assumptions can be applied (e.g., alone or in combination with other assumptions described herein):
All shelves are more than or equal to the minimum length item (product)
All items (products) are less than or equal to the maximum shelf length
There are no products with a number of facings greater than available shelf space
Model are used with or without stacking or rotations of the products inside the shelf
Facing, stacking, and/or rotation variations are implemented using avatars
A single/multiple objective function is used for rank, revenue, profit, etc. objectives
Simple linear objectives are used, and no non-linear objectives are used (linearization and relaxations are applied to convert non-linearity in objectives)
No elasticity is used (elasticity, if provided, can be used prior to adjusting the inputs such as expected sales) (elasticity that can be factored in includes price, space, and cross elasticity)
Stacking behind a product facing is done using the same product
Stacking above a product facing can be done using the same product or different products
Height, weight, and depth constraints are not elaborated as equations (shelf and/or product)
Shelf width is equal for all shelves in a particular section and/or fixture (one fixture may contain one or many sections)
Shelf and section/fixture are rectangular entities only (approximations are applied to make it rectangular for non-rectangular entities)
Any implicit loss of space due to fixture components is ignored

In the techniques and solutions described herein, one or more of the following product dimension assumptions can be applied (e.g., alone or in combination with other assumptions described herein):
Same products goes behind in the facing
Same product goes beside as one facing
Same product goes above as one facing
Same height product goes on same level
Same width product goes on same level
Same depth product goes on same level
Same height and width product goes on same level
Same height and depth product goes on same level
Same depth and width product goes on same level
Product with its facings and/or stacking and/or rotation is one logical product
Each product and/or logical product can only be selected once
Empty space (if desired) is treated as a null product with variable length, width, and depth
One product can span many space cells (space cells are a specific representation of s-cells, where s-cells can encode space, product, and/or other data), or one product can be allocated only to one space cell
All products can be treated as a rectangular shape according to the nearest shape in 2d or 3d
Products can or cannot be arranged on top of one another
Products which are to be arranged on top have a lesser width than bottom product
Products can be rotated only in allowable ways (e.g., limited allowable ways) for the best fit out of all possible arrangements resulting in new length, width, and depth

In the techniques and solutions described herein, one or more of the following space dimension assumptions can be applied (e.g., alone or in combination with other assumptions described herein):
One cell can be one location or one location can be made of many cells
One location is occupied by one logical product
Number of locations horizontally cannot be greater than the shelf width
Number of levels cannot be greater than the shelf height divided by minimum height of the logical or physical products
All cells are orthogonal in nature and all cell walls are parallel to container or shelf
All locations cells at one level may or may not have equal dimensions
All locations cells at one level have equal height
All locations cells at one level may or may not have equal width
All locations cells at one level have equal depth
All locations cells at one level have equal height and/or width dimensions
All locations cells at one level have equal height and depth dimensions
All locations cells at one level have equal depth and/or width dimensions
All cells are square or cube
All cells are rectangles of fixed or variable size and dimension
All cells at one level are the same shape (e.g., either cube or rectangle)
All cells at one level are of the same or different dimensions
All space can be digitized, or arranged in a grid pattern, into cells (this grid is called an s-grid which is grid of s-cells)
All locations can be mapped onto cells
All locations can be classified as merchandisable or non-merchandisable cell units
No location can be occupied by more than one product unless one location can be made up of more than one cell and hence one product can be mapped to more than one cell
Logical locations increment irrespective of nulls or empty space which are null locations
All locations are tagged uniquely beginning from the top-left, and continuing down with a similar tagging or identification strategy

One or more of the above one or many relaxations, approximation, and/or assumptions can be used to dynamically create a variant of a model (e.g., using a base model). For example, a variant of a base model can be created to facilitate optimizations (e.g., to make optimizations more efficient or possible in certain situations).

In a specific implementation a simplified model is created using the following set of assumptions:
No stacking or rotations of the products inside the shelf
Facings variations are implemented as avatars
A single objective function in rank, revenue, and profit
A simple linear objective and no nonlinear objective
No elasticity is used
Product being stacked behind its facing by the same product
Height, depth, and/or weight constraints are not elaborated as equations
All shelves have equal width
Shelves and fixtures are rectangular
Any implicit loss of space due to fixture components is ignored

### Example Constraints

Constraints refer to rules (such as business rules or merchandising rules) that can be used when determining a solution (e.g., an optimal solution) to a product selection and/or assortment problem. Two example constraints are: “Product X must be placed at eye level on the shelving unit” and “A minimum of N units of product X must be placed on the shelving unit.”

The following are additional examples of constraints. One or more of the following constraints can be used when determining optimal assortments and/or planograms (e.g., separately or in combination with other constraints described herein).
Specific items should go on specific shelf
Specific items should not go on specific shelf
Item must be selected
Item must not be selected
Some items cannot be placed together
Some items must be selected/rejected together and placed together
Some items must be selected together but can be placed anywhere
From a given subset of items only limited number of items must be selected
Items cannot be selected together
Items to be selected together but placed separately
Item has to be selected, but can go anywhere
Item has to be selected and should not go on a specified shelf
Item may be selected, and if so, is to be placed on a specified shelf
From a given subset of items, a minimum number of items must be selected
From a given subset of items, only specified number of items must be selected
Item may be selected, and if so, is to be placed on a specified shelves
Items should go on specific shelf and at specific location(s) on the shelf
Specific items should not go on specific shelf at specific location(s)
Equal number of items from two product sets have to be selected
Item must be selected and must go on specified shelf
Group of products all must be selected and at least some must go specified shelf
Item(s) may be selected, and if so, are to be placed on specific shelf at specific location(s)
Allocate specified percentage of the space to the particular items from the group or item(s) on the particular set of shelves or at fixture level

The following are additional examples of constraints. One or more of the following constraints can be used when determining optimal assortments and/or planograms (e.g., separately or in combination with other constraints described herein).
Must Select Top X Items from each Category
Must Select Top X Items from each Sub-Category
Must Select Top X Items from each Brand
Must Select Top X Items from each Class
Has to carry at least X Items from each brand under this Category
Has to carry at least X Items from each brand under this Sub-Category
Has to carry at least X Items from each brand under this Class
Must Select Top X sales Product
Must select more than X items of Category for this Shelf
Must select more than X items of Sub-Category for this Shelf
Must select more than X items of Brand for this Shelf
Must select more than X items of Class for this Shelf
Not to select more than X items of Category for this Shelf
Not to select more than X items of Sub-Category for this Shelf
Not to select more than X items of Brand for this Shelf
Not to select more than X items of Class for this Shelf
Keep the Top X selling brands for Category on Shelf
Keep the Top X selling brands for Sub-Category on Shelf
Keep the Top X selling brands for Class on Shelf
Associate particular Category to particular Shelf
Associate particular Sub-Category to particular Shelf
Associate particular Brand to particular Shelf
Associate particular Class to particular Shelf

### Example Product Assortment and Planogram

In the techniques and solutions described herein, optimization can be performed for a product assortment and associated planogram. For example, a product assortment can comprise one or more products. Products can be defined by product attributes, such as name, margin, expected sales, sales rank, facings (number of the same product to appear, such as on a shelf or shelving unit), dimensions, weight, UPC, group or sub-group, category or sub-category, class, etc. A planogram can describe the placement of products (e.g., on a shelf), which can include specific product locations, number of facings, rotation, etc.

In a specific implementation, the product attributes comprise the following: ProductId, Margin, Rank, Effect, Facings, ProductWidthInUnits, ProductHeightInUnits, MinFacings, MaxFacings, Depth, InventoryOverHead, ReplenishmentOverHead, OtherOverHead, ExpectedSalesUnit, IsFiller, ReplenishmentDays, IsBackRoom, MinCasePackOnShelf, MinDisplayUnits, ProductCasePackSize, ProductType, ProductTypeBusiness, Perishable, Fragility, ColorTheme, StyleTheme, ProductSize, ProductWeight, ProductWeightBearingCapacity, ProductValue, SpecialNeeds, ProductBudget, UPC, SKU, and CategoryId

Table 1 below depicts a simplified example listing of five different air freshener products with their associated product attributes.

TABLE 1
Product Assortment

| | | | | Min | Max | | |
|---|---|---|---|---|---|---|---|
| Product | Margin | Rank | Facings | Facings | Facings | Dimensions | Weight |
| Air freshener—Product 1 | 70% | 2 | 2 | 1 | 3 | 1″ × 3.5″ × 5.9″ | 0.21 |
| Air freshener—Product 2 | 70% | 5 | 2 | 1 | 3 | 1″ × 3.5″ × 5.9″ | 0.21 |
| Air freshener—Product 3 | 70% | 8 | 2 | 1 | 3 | 1″ × 3.5″ × 5.9″ | 0.21 |
| Air freshener—Product 4 | 70% | 11 | 2 | 1 | 3 | 2″ × 3″ × 3.5″ | 0.23 |
| Air freshener—Product 5 | 70% | 14 | 2 | 1 | 3 | 2″ × 3″ × 3.5″ | 0.23 |

For example, a set of products (e.g., as defined in Table 1 above) can be received. From the set of products, an optimal product assortment can be selected and an optimal planogram can be determined from the product assortment. For example, the optimal product assortment can comprise some or all of the products listed in the set of products. The product assortment can include specific products, number of facings for the specific products, placement (e.g., at a specific location on a shelf), etc. for example, a product assortment using Table 1 above could be Product 1 located at a first location on shelf 1 with three facings, followed by Product 3 located at a second location on shelf 1 with four facings, and Product 4 located at a third location on shelf 1 with two facings.

### Example Features

In the techniques and solutions described herein, one or more of the following features can be applied:
Optimization of a product assortment and planogram (POG) for a store and/or cluster and/or one or many seasons (e.g., product IDs or stock-keeping units (SKUs) as well as positioning on a shelf with appropriate facings)
   By rank
   By profit
   By Revenue
   With fixed or variable facings
Management of rules and/or constraints for a store and/or cluster and/or one or many seasons to be used in the optimization operations
Workflow for sign-off of a planogram assortment

### Example Business Flow

In the techniques and solutions described herein, one or more of the following business flow operations can be applied:

1. User can create a category centric project for pre-season or in-season planning

2. User can import or link existing initial assortment plan and/or POG (planogram)
a. Optionally, user can create POG template (either by rules or by optimization)

3. User can create or import potential assortment set from existing assortment plan and/or using other available data such as sales, product dimensions, etc.

4. User can create initial merchandise strategy for category, cluster/store, or a season
a. Strategy can contain POG template, other rules related to fixture data and/or identification of proper assortment, presentation, supply chain, pricing, budget, promotions, inventory rules, etc. (e.g., as constraint instances)
b. User can then do the “what-if” analysis to define or refine any parameters in assortment set, strategy constraint set, or fixtures to trigger the optimization
c. User can then inspect the output of optimization run and evaluate the POG, assortment set, and return on space, return on inventory, shelf utilization, and/or recommended inventory, etc.
d. User may save the scenario, POG, and/or assortment set for later use
e. During the planning cycle, user may change existing strategy or create new strategies and perform what-if analysis to arrive at best possible values for return-on-investment (ROI) and/or return on space (ROS) (e.g., using per category goals)

5. User, if satisfied, can then freeze the POG and/or assortment set and send it for sign-off

### Example Base Workflow

In the techniques and solutions described herein, a base workflow can include one or more of the following operations:

1. Review the merchandising strategy

2. Create category project and create/review the assortment set and its attributes

3. Select input to optimization, and optimize by objective function such as rank, profit, revenue, etc.

4. Optimize by profit, rank, or revenue but with fixed facings for the same assortment set and compare the output results with other objective function optimization; observe any increase in POG performance metrics like return-on-sales (ROS) and/or return-on-investment (ROI)

5. Optimize by profit, rank, or revenue with variable facings for the same assortment set and compare the output results with other objective function optimization; observe any increase in POG performance metrics like ROS and/or ROI

### Example Optimization by Rank

In the techniques and solutions described herein, a product assortment can be optimized based on rank (sales rank of the products in the assortment). Optimization based on rank can be performed using fixed facings or with variable facings.

Results can be generated from optimizing a product assortment by rank. For example, the results can comprise optimal assortments and/or planograms (e.g., containing recommended products selected from a set of possible products from which some or all of the products can be selected for the assortment and other unselected products can be dropped), total expected revenue, total return on space, total fixture utilization, and value per unit of space (e.g., per linear foot).

### Example Optimization by Profit

In the techniques and solutions described herein, a product assortment can be optimized based on profit. Optimization based on profit can be performed using fixed facings or with variable facings.

Results can be generated from optimizing a product assortment by profit. For example, the results can comprise optimal assortments and/or planograms (e.g., containing recommended products selected from a set of possible products from which some or all of the products can be selected for the assortment and other unselected products can be dropped), total expected revenue, total return on space, total fixture utilization, and value per unit of space (e.g., per linear foot).

### Example Optimization Using Variable Facings

In the techniques and solutions described herein, a product assortment can be optimized using a variable number of facings. Generally, optimization can be performed using a fixed number of facings (e.g., 3 facings per product on a shelf or shelving unit) or a variable number of facings. For example, the variable number of facings can be implemented as a range (e.g., between 2 and 4 facings per product on a shelf or shelving unit).

Optimization of a product assortment can be performed based on rank, profit, and/or revenue with fixed or variable facings.

### Example Optimization using Avatars

In the techniques and solutions described herein, an avatar refers to a group or collection of products (e.g., one or more instances of the same product or one or more instances each of different products) that are treated as a single product (e.g., a single entity) for placement and optimization. For example, an avatar can be created for a group of four instances of the same air freshener product in a specific arrangement (e.g., the four products side-by-side or two products stacked and/or rotated on top of two products). The products in an avatar group (which can be called an avatar product) can each have the same number of facings (e.g., a specific number of facings between a minimum number of facings and a maximum number of facings), or the products in the avatar group can each have different number of facings (e.g., an independent number of facings).

Avatar products can be created in advance or at another time before running an optimization process. For example, avatar products can be created ahead-of-time based on different criteria, such as store, cluster, season, etc. For example, specific avatar products can be created for a specific store for a specific season (these pre-created avatar products can then be selected at run time when performing the optimization run to determine the optimal product assortment and/or planogram).

In a specific implementation, avatars can be created with variation in number of facings, stacking, rotation, and location. For example, an avatar can specify a number of facings of one or more of the same, or different products. The avatar can specify stacking of the products (e.g., vertical, horizontal, and/or depth stacking). The avatar can specify rotation of the products (e.g., which side of the product will be facing forward). The avatar can also specify location (e.g., if the avatar is to be placed at a specific location, such as on a specific shelf of a shelving unit, or at a specific location on a shelf).

Depending on implementation details, one or more of the following features can be used to implement avatars:

1. Avatars can provide an easy and intuitive solution for merchandisers to place products on the shelf, and can also provide per-determined logical groupings of products

2. Avatars can provide for grouping of product instances for vertical stacking (vertical facings) as a logical product

3. Avatars can provide for grouping of product instances for horizontal facings as a logical product

4. Avatars that group different product types can be used to treat the group as a single product

5. Avatars can also allow for variation of expected sales in units for each logical grouping instance (e.g., space elasticity measured with respect to allowed facings)

7. Avatars can reduce the dimensional complexity of the model (e.g., design time as well as run time benefits as solvers tend to be slow with increasing dimensions)

8. Avatars also facilitate application of the rules/constraints on a single logical entity and hence reduce the number of combinations for performing optimization runs

9. Avatars can also be created to facilitate promotion of two different products if these products are to be sold together in which case both the products along with their stacking and/or rotation will constitute one logical product. All logical products will behave exactly like normal products. In creation of logical products margin and expected sales can be adjusted to reflect oneness of the entity E.g. Margin individual products belonging to that logical product can be added to be the margin of entire assembly while sales can be larger of the two.

Depending on implementation details, avatar information comprising one or more of the following avatar attributes can be used to define avatars.

ProductId;

AvatarId;

AvatarName;

AvatarHeight;

AvatarWidth;

AvatarDepth;

AvatarPricingPerUnit;

AvatarExpectedSalesPerUnit;

AvatarMinimumFacings;

Locations;

Levels;

Orientation;

ImageUrl;

FaceOnDisplay;

IsDefault;

ValidAvatar;

IsCurrent;

IsSelected;

AvatarMargin;

InventoryOverHead;

ReplenishmentOverHead; and

OtherOverHead

In a specific implementation, the following pseudo-code is used in the optimization techniques described herein to implement avatars. The pseudo-code supports variations in number of facings and variation in stacking (e.g., vertical and/or horizontal), and supports locations including localization for stores, fixtures, shelf width/height, and demographics.

Basic process:
1. Create avatars (statically by the user or dynamically by the system)

1.1. Before, manually by user, or

1.2. Dynamically during pre-optimization stage
1.1.1-2 Perform inside optimization, as indicated below
   2. During optimization
   3. After, post optimization
   Creation of static or dynamic (pre-optimization) avatars of products:
   1. For all departments

1.1. For all categories
1.1.1. For all products and specific to each store or cluster
   1.1.1.1. For specified no of rotations
      1.1.1.1.1. For specified number of horizontal facings
         1.1.1.1.1.1. For specified number of stacking facings
         1.1.1.1.1.1.1. Create product group, product set of that product containing different representations of the same products as appropriate to demographics, store
            Perform inside optimization:
1.1.1. Create a dynamic constraint which allows selection of only one product out of set of products
1.1.2. For each product which has avatar product set
   1.1.2.1.1. Select only one product out of all the products in that “product avatar set” for that product
      Perform post optimization: map back the recommended avatar by optimization to original product.

### Example Optimization Algorithms

In the techniques and solutions described herein, one or more optimization algorithms can be used to determine an optimal (or near optimal) set of products (e.g., a set of products to for placement on a shelf or shelving unit).

In a specific implementation, the following optimization algorithm components are used:

1. problem type and domain specific instance itself

2. input dimensional hierarchies and types
a. including any reference data sets and/or parametric configurations

3. outputs and their types

4. transformational functions (techniques) from the source dimensional hierarchies to target unfolded hierarchies

5. algorithmic structural taxonomy operated by algorithms

6. hybrid algorithms working in conjunction or recursion or iteration

7. constraints (e.g., generic types and specific types and their instances) representing various associations amongst the entities indicating various different types of general or specific business rules for various domains

8. generic domain abstraction and specialization of the context where problem is poised, creating generic or specific relaxations, assumptions, and approximations

In a specific implementation, the following pseudo-code is used to perform optimization for a product assortment:

1. read input dimensions and hierarchies; read reference data and explicit user provided constraints

2. transform input dimensions and hierarchies into algorithmic and structural graphs of s-cell according to the current domain (e.g., using a hybrid binary multi-mlulti-2d/3d knapsack model)
a. unfold the hierarchies inside each dimension on a specific internal axis as appropriate and encode them in s-cell structures on that axis
b. define the decision variables (s-cell specializations) as appropriate to the problem statement and internal structure
c. apply various relaxations, approximations, and assumptions in the form of constraints and structural simplifications or specialization
d. create implicit constraints to enforce the structure of the algorithm and correctness of entities involved
e. use collections of domain specific and domain independent rules as provided by users

3. create heuristics graphs for parallelization (e.g., implicit or explicit)

4. generate the dynamic model as per the multiple or single objectives

5. generate the explicit and implicit constraints files

6. solve the generated model hierarchies and model assemblies

7. analyze the result from optimization run and if solution is optimal:
a. generate set of decisions, output dimensions, hierarchies, and optimal solution contained by the resulting decision variables
b. apply post transformations, or reverse transformation (for any avatars) on the result if needed to finalize the optimal entity to be displayed or output

In a specific implementation, the following pseudo-code is used to perform optimization for a product assortment:

1. Identify/define set of items in groups at input of product hierarchy representing the potential assortment data available

2. There are finite knapsacks at input, each with width, height, weight, and depth; knapsacks are mutually exclusive and create a graph of associations as a single unit; multiple knapsacks working together; each knapsack is essentially a shelf or sub shelf or a logical shelf part of some fixture; multiple knapsacks constitute a logical or physical fixture to be allocated

3. The above data along with some other dimensional entity represents input N dimensions where each dimension represents some domain entity involved such as products of potential assortment or category or groups, space-fixtures-shelves, time, etc.

4. Each dimension has nodes which will be transformed; pre-transformation sets are created

5. The process of specific unfolding is performed on the dimensional hierarchies and source to target transformation is performed on the above input dimensions and sets
a. Transformations are specific to the problem type and algorithm, and are created as pictures of the source or target universe of feasible solutions; a picture (s-grid) is made up of s-cells, where s-cell encode information with respect to dimensional data, hierarchical data, objective function data, and are treated as a combined decision variable
b. The structure is enforced by implicit constraints
c. This is accomplished by defining the concept of s-cell; by defining s-cell as an encoding of information of multiple dimensions and hierarchies, different structures are created (e.g., assemblies or graphs of s-cells encapsulating properties of domain objective function along with domain entities) statically or dynamically to facilitating mimicking different algorithms or to generalize the different problem statements; structures of s-cell are enforced by means of generic of specific constraint of association of multi-dimensional entity-hierarchies and its unfolding on internal axis where structure is established:
   s-cell as a whole or part of decision variable which has cell x component, y component, z component
   where cell x component=Transform(dimension1.hierachy1-Node, . . . dimension1.hierarchyN-Node)
   cell y component=Transform(dimension2.hierachy1-Node, . . . dimension2.hierarchyN-Node)
   cell z component=Transform(dimension3.hierachy1-Node, . . . dimension3.hierarchyN-Node)
   objective function=maximize function of Profit or Revenue or Rank or Multiple Objective as a (sum(all s-cells, s-cells in frame, decision variable)
   Whether specific s-cell is part of the internal picture or point of optimality becomes a yes/no decisions variable either set implicitly (implicit constraint) or set by the optimization run at the output based on optimality accomplished

In a specific implementation, the following avatar pseudo-code is used to define “avatars” of products. For example, an avatar can be used to define a group of two or more products that can be included as a single product (e.g., an “avatar product”) in a product assortment for optimization. Avatars can be defined for different purposes, such as per-season, based on demographic information, or based on cluster information. The example avatar pseudo-code is listed below:

1. Allow retail merchandisers to create valid “avatars” of the products (e.g., per season, demographics, or cluster)

2. Allow retail merchandisers to specify different sales measures or rank per avatar of the product

3. Treat avatars as single internal dummy product being mapped to external product having the facings or width or as per that avatar of the product

4. Allow merchandisers to use these avatars of products in input data, what ifs', and for optimization or as input argument to constraint types

5. Generate avatar specific constraints with one additional special constraint to only choose one (and not more than one) of the possible avatars of the products (e.g., allow optimizer to prefer the one which maximizes the objectives with constraints)

6. Create optimal version of the planogram with avatars of products (e.g., transforming real product to internal dummy product and transform back as needed)

The concept of using s-cells and s-grids for micro optimization problems (and problem sub-types) can be described as follows. S-cells encode information with respect to dimensional data, hierarchical data, objective function data, and are treated as a combined decision variable. In a specific implementation, the following problem sub-type provides a two-dimension solution using space and product-merchandising dimensions.

Problem sub type 1

Each product has default number of facings (no facings variations), across only location,
with product stacking or rotations, and no depth considerations on shelf, within one
fixture and one section only, and with default season (no time dimension is used)

| Input 1 | input 2 | No time input |
|---|---|---|
| space dimension | merchandising-product | No time dimension |
| and hierarchy | dimension and hierarchy | |

s-grid-s-cell internal transformation on x-y axis is internal representation,
s-grid: memory structure and storage repository (e.g., spreadsheet or database) to sync with optimization
s-cell: memory structure and storage entry (e.g., spreadsheet cell or database entry)

| y-axis | x-axis |
|---|---|
| shelf-id, location-id | product-id |
| Output(s) | s-grid with only selected products |
| | and shelf-location indicated as being |
| | selected (e.g., having a “1” for their |
| | entry) |

In another implementation, the following problem sub-type provides a three-dimension solution using space, product-merchandising, and time dimensions.

Problem sub type 2

Sub-type with facings, stacking, and rotations amongst multiple fixtures, each made up of
multiple sections and sections contains shelves, shelves having locations and each location
having stacking level id and depth id

| Input 1 | input 2 | input 3 |
|---|---|---|
| space dimension | merchandising-product dimension | time dimension |
| and hierarchy | and hierarchy | and hierarchy |

s-grid-s-cell internal transformation on x-y-z axis is internal representation,
s-grid: memory structure and storage repository (e.g., spreadsheet or database) to sync with optimization
s-cell: memory structure and storage entry (e.g., spreadsheet cell or database entry)

| y-axis | x-axis | z-axis |
|---|---|---|
| fixtture-id_section- | product-id, facing-id, rotation-id | year-id_season-id / |
| id_shelf-id_location- | | year-id_month-id/ |
| id_level- | | year-id_month-id_week-id |
| id_(optionally : depth-id) | | |
| Output(s) | Internal : | |
| | s-grid with only selected products such | |
| | as that the entry with “product-id, | |
| | facings-id, rotation-id” and “fixture-id, | |
| | section-id, shelf-id, location-id, level- | |
| | ids” is selected (e.g., that entry contains | |
| | “1” for its entry or cell), all such | |
| | selected entries reflect the selection of | |
| | that choice. If using a worksheet | |
| | solution, either each worksheet can | |
| | indicate values for aggregate time | |
| | dimension or each atomic time | |
| | dimension can have its own worksheet | |
| | (optionally each worksheet can itself | |
| | contain the 3^{rd} dimension as embedded | |
| | repetitions across rows and columns) | |

### Example Parallelization Strategies

In the techniques and solutions described herein, parallelization strategies can be applied to the optimization techniques described herein.

In a specific implementation, explicit parallelization is performed according to the following pseudo-code, which involves automation across departments (each for loop is spawned as a separate job):

1. For each department or input departments

1.1. For each category or input categories
1.1.1. Optionally for each subcategory
   1.1.1.1. For each store or store cluster or input stores
      1.1.1.1.1. For each season or input seasons
         1.1.1.1.1.1. Create & add optimization job with fixture/section or bay, constraint set: strategy, store I cluster, season for category request
      1.1.1.1.2. Next season
   1.1.1.2. Next store in a cluster or cluster in an enterprise
1.1.2. Next subcategory (optionally)

1.2. Next category

2. Next department
3. Execute job tree on grid using distributed or parallel computing and aggregate result

In a specific implementation, implicit parallelization is performed according to the following definitions and rules:
Inputs: fixture-shelves, assortment set, and merchandising strategy—list of constraints
Outputs: mutually exclusive assortment sets, constraints lists working on subset of total shelves
Break merchandising strategy and assortment set into mutually exclusive sets of constraint buckets (CB)
Definition of Constraint bucket: bucket of shelves or shelf along with product set attached to them which obeys identity such as: each CB set has 2 components, first one is constraint bucket shelf (CBS) or shelves component and second one is constraint bucket product (CBP) of products components and each of these two sets obeys following rules:
Rule 1: the intersect of all CBs with each other is 0 or null, i.e., no to CBs have any shelves in common
Rule 2: union of all CBS=set all shelves in all fixtures
Rule 3: no two CBs have the same product, i.e., intersection of CBPs of CBs is null for all products which are part of some constraint instance (CI), however product which are not part of any constraint instance can be distributed across the CBPs either manually or using a configurable editable where clause

In the specific implicit parallelization implementation, three functions are created, three filters or validations for the three rules described above after which any CBS and CBP i.e. CB are created or appended.

A simplified pseudo-code for performing the implicit parallelization is as follows:

1. For the constraint instances involving product to product assortment set

1.1. Add to the CBP which already has those products, if there is none such CBP then wait till the end (accumulate it to common bucket)
1.1.1. At the end iterate through the common bucket the rule 2
   1.1.1.1. If NULL even at the end of the loop then use the predefined where clause to distribute them across CBs
      2. For the constraint instances involving positive products to shelf or shelf set association

2.1. Product or products go on shelf or shelves
2.1.1. All products targeting that shelf or shelf group (SG)
   3. For the constraint instances involving negative products to shelf or shelf set association

3.1. Product does not go on shelf or shelves

4. Read constraint instance (CI)
5. If CI==of type mentioned in step 3 (i.e. involves one or more shelves)

5.1. Is it targeting shelf or shelf group
5.1.1. If shelf then check if shelf group CB (constraint bucket) for that shelf exists
   5.1.1.1. If so then add that CI and products to that CB
      5.1.1.1.1. If all products of that CI exists in CBP then ok
      5.1.1.1.2. Else add products of that CI to CBP
         5.1.1.1.2.1. CBP=CBP+different or products in CI and existing products in CBP
   5.1.1.2. Else Create new atomic unit group of CB as made of single shelf and add to CBS all shelves and add product or products to its CBP group
      5.1.1.2.1. Again make sure that there is no other CBP whose intersect with newly formed CBP or current CB'S CBP is not null
         5.1.1.2.1.1. If there is one such group then merge those two CB i.e. merge CBS and that CBP to create a new CBS and CBP and new bigger CB
5.1.2. Else if targeting==shelf group then check if exact CB match exists
   5.1.2.1. If no match then find the CB set which has maximum match, such that all shelves belonging to that CB belong to (are contained) in current shelf group and make current shelf group as CB, add the shelves missing in that CB to itself
      5.1.2.1.1. CB=CB+different in the sets of (SG-CB)
         6. At the end add remaining products to respective CBP based on the where clause
         7. Create implicit job tree
         8. execute the jobs

### Example Models and Equations

In the techniques and solutions described herein, optimization of a product assortment can be performed, at least in part, using models and/or equations.

For the models and equations described in this section, the following simplifications, relaxations, and approximations can be used for better performance or for achieving the result:

1. All fixtures are made up of only one section.

2. All shelve are of the same dimensions.

3. All products can have only 1 or 0 facings (0 facings means the product not selected).

For the models and equations described in this section, the following implicit constraints are used:

1. Height, width, depth, and optionally weight for each item selected (standard product or avatar product) and placed onto a shelf has to be less than the selected shelf height, width, depth, and optionally weight (acceptable weight capacity of the shelf—how much weight can be put onto that shelf).

2. Shelf capacities are not to be violated.

3. Optionally an item can be allocated to one shelf only and can be selected or not selected (for most common planograms, items are carried in one shelf only hence this constraint will be used more often based on the product placement strategy).

4. Only binary values (selected or not) allowed for product selection.

The following notations and definitions are used for one of the models (elementary model) and equations described in this section are for this type of elementary model:

ShelfIndex=set index identifier for shelves

ItemIndex=set index identifier for items

SetOfShelves=complete set of shelves that constitute fixture or section

SetOfItems=complete set of items that are available to be allocated onto shelves

NoOfShelves=number of shelves in fixture/section

NoOfItems=number of items in set of items

Profit_{ItemIndex}=profit per item index

Score_{ItemIndex}=score per item index—a linear function to derive the score for sales (e.g., higher sales for the product higher the sales score)

WidthOfProduct_{ItemIndex}=width of the item for ItemIndex th Item

HeightOfProduct_{ItemIndex}=height of the item for ItemIndex th Item

DepthOfProduct_{ItemIndex}=depth of the item for ItemIndex th Item

WidthOfShelf_{ShelfIndex}=width of the shelf for ShelfIndex th Shelf

WeightBearingCapacityOfShelf_{ShelfIndex}=weight bearing capacity of the shelf for ShelfIndex th Shelf (this facility of weight validation is optional)

HeightOfShelf_{ShelfIndex}=height of the shelf for ShelfIndex th Shelf

DepthOfShelf_{ShelfIndex}=depth of the shelf for ShelfIndex th Shelf

IsProductOnShelfKnapsack=decision variable for product and shelf associations-primary binary multi-knapsack which will be populated

HINUM: large number>>NoOfItems*currently used as one of the linear functions for arriving at score function

The following objective functions can be used to maximize profit for a product assortment or to maximize rank (e.g., sales score) of a product assortment. Equation 1 is an objective function for maximizing profit.

Maxamize AggregateProfit=Σ_{ShelfIndex=1}^{NoOfShelves}Σ_{ItemIndex=1}^{NoOfItems}Profit_{ItemIndex}IsProductOnShelfKnapSack_{ShelfIndex ItemIndex} (Equation 1)

Equation 2 is an objective function for maximizing rank.

Maxamize AggregateRank=Σ_{ShelfIndex=1}^{NoOfShelves}Σ_{ItemIndex=1}^{NoOfItems}Profit_{ItemIndex}IsProductOnShelfKnapSack_{ShelfIndex ItemIndex} (Equation 2)

Implicit Constraint Equations.

The following equations enforce implicit constraints. Depending on implementation details, one or more (or none) of the following constraints can be applied. Equation 3 is an implicit constraint equation for product width (similar equations can be used for product height and depth constraints).

Σ_{ItemIndex=1}^{NoOfItems}WidthOfProduct_{ItemIndex}IsProductOnShelfKnapsack_{ShelfIndex ItemIndex}≦WidthOfShelf_{ShelfIndex}∀ShelfIndexεSetOfShelves (Equation 3)

Equation 4 is an implicit constraint equation for selection of one product instance.

Σ_{ShelfIndex=1}^{NoOfItems}IsProductOnShelfKnapSack_{ShelfIndex ItemIndex}≦1∀ItemIndexεSetOfItems (Equation 4)

Equation 5 enforces the binary knapsack constraint.

IsProductOnShelfKnapSack_{ShelfIndex ItemIndex}={0,1} (Equation 5)

Equations 6 and 7 impose constraints on width. Similar equations can be used to impose height and depth constraints.

WidthOfProduct_{ItemIndex}≦Min_{ShelfIndexεSetOfShelves}{WidthOfShelf_{ShelfIndex}} (Equation 6)

WidthOfShelf_{ShelfIndex}≧Min_{ItemIndexεSetOfItems}{WidthOfProduct_{ItemIndex}} (Equation 7)

Optional Base Constraints.

Any of the constraints described herein can be implemented using constraint equations. For example, Equation 8 enforces the constraint that ProductId1, ProductId2, . . . cannot be placed together on any given shelf (ShelfIndex). This constraint can be applied for all shelves (all ShelfIndex values).

IsProductOnShelfKnapSack_{ShelfIndex,ItemIndex=ProductId1}+IsProductOnShelfKnapSack_{ShelfIndex,ItemIndex=ProductId2}+ . . . ≦1∀ShelfIndex (Equation 8)

Similar to Equation 8 above, other equations can be used to enforce optional base constraints, including one or more of the constraints described herein.

Explicit Constraint Equations.

The following equations enforce explicit constraints. Depending on implementation details, one or more (or none) of the following constraints can be applied. Equation 9 is an explicit constraint equation stating that a specific item should go on a specific shelf (that item ProductId1 has to be selected and placed on shelf S1).

IsProductOnShelfKnapsack_{ShelfIndex=S1,ItemIndex=ProductId1}=1 (Equation 9)

Equation 10 is an explicit constraint equation stating that a specific item should not go on a specific shelf (that item ProductId1, if selected, should not be placed on shelf S1).

IsProductOnShelfKnapsack_{ShelfIndex=S1,ItemIndex=ProductId1}=0 (Equation 10)

Equation 11 is an explicit constraint equation stating that specific products are selected together but are placed on different shelves.

Σ_{ShelfIndex}(IsProductOnShelfKnapSack_{ShelfIndex,ItemIndex=ProductId1}++IsProductOnShelfKnapSack_{ShelfIndex,ItemIndex=ProductId2})=2 (Equation 11)

Equation 12 is an explicit constraint equation stating that specific products are not to be selected at all.

Σ_{ShelfIndex}(IsProductOnShelfKnapSack_{ShelfIndex,ItemIndex=ProductId1}++IsProductOnShelfKnapSack_{ShelfIndex,ItemIndex=ProductId2})=0 (Equation 12)

### Methods for Determining an Optimal Set of Products and an Optimal Planogram

In the techniques and solutions described herein, methods can be provided for determining an optimal set of products and an optimal planogram to be carried for a product assortment (e.g., for a shelf, shelves, and/or shelving unit).

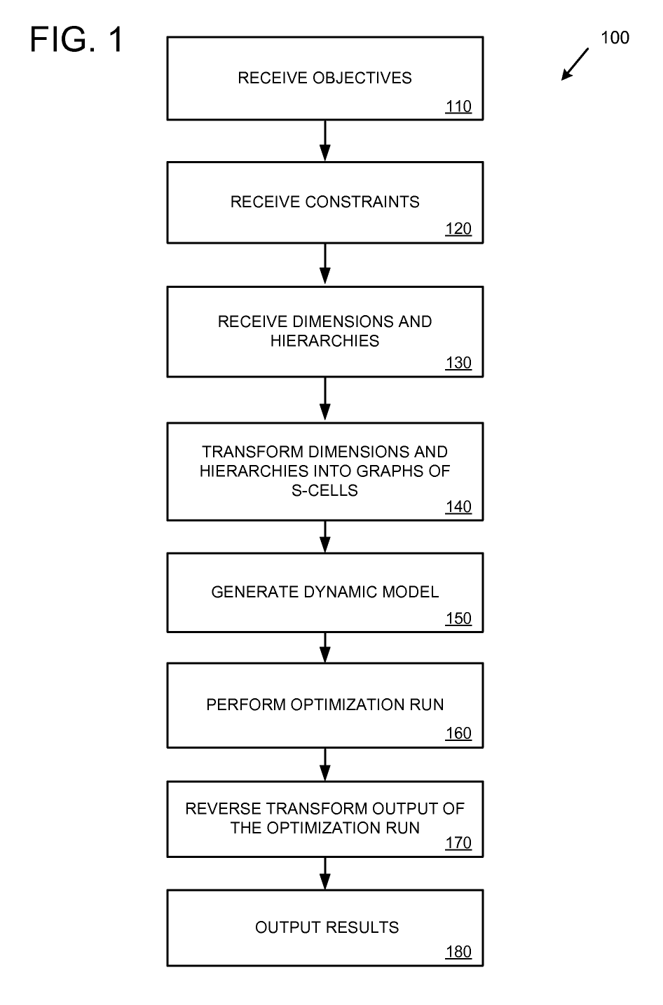

FIG. 1 is a flowchart depicting an example method 100 for determining an optimal set of products to be carried for a product assortment and an optimal planogram using a hybrid binary multi-dimensional knapsack representation. At 110, one or more objectives are received. In a specific implementation, at least one of profit, rank, and/or revenue objectives are received. At 120, one or more constraints are received. For example, the constraints can permit a variable number of facings for the products.

At 130, dimensions and hierarchies are received. At 140, the received dimensions and hierarchies 130 are transformed into structural graphs of s-cells. S-cells represent a technique and accompanying data structure corresponding to a polymorphic, dynamic, multi-dimensional decision variable along with constraints and additional attributes.

At 150, a dynamic model is generated using, at least in part, the one or more objectives 110. At 160, an optimization run is performed using the generated dynamic model 150.

At 170, a reverse transform is performed on the output of the optimization run 160. The reverse transform can be used to transform the output into recommended optimal domain specific entities from the s-cell structure used at 140. The reverse transform can be used to transform the output into an optimal assortment and an optimal planogram.

At 180, results of the optimization run, which have been reverse transformed, are output. For example, the results can comprise a list or display of the optimal set of products, along with location information (e.g., location of each product on a shelf, such as in the format of a planogram). The results can also comprise, for each of one or more products of the product assortment: a location of the product, and a number of facings for the product. Result can also include financial and planogram performance metrics (e.g., ROS and/or ROI).

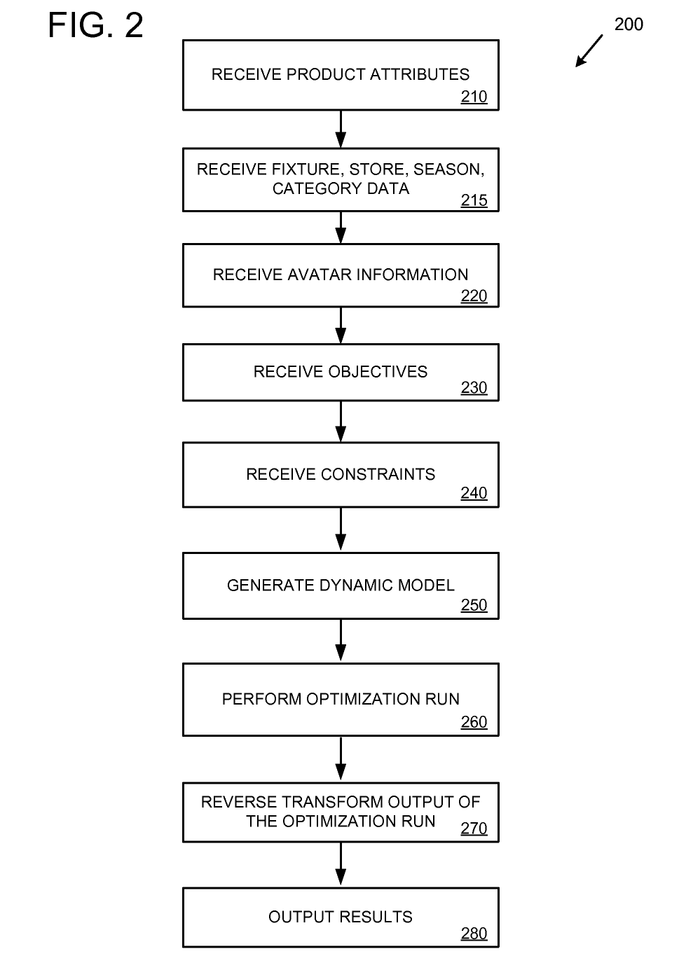

FIG. 2 is a flowchart depicting an example method 200 for determining an optimal product assortment and an optimal planogram. At 210, product attributes for a set of products are received. For example, the product attributes can include attributes such as: price, margin, expected sales, rank, number of facings, dimensions (e.g., height, width, depth), and/or weight.

At 215, fixture data is received. For example, the fixture data can comprise information describing a shelf (e.g., height, width, and/or depth of the shelf) or multiple shelves (e.g., comprising a shelving unit). Additional data can be received, such as cluster/store information, season information, category/sub-category information, etc.

At 220, avatar information is received for the set of products. The avatar information describes, for one or more avatar products, which products are included in the avatar product. For example, an avatar product can include a plurality of the same product (e.g., three instances of a specific air freshener product arranged side-by-side. An avatar product can also include different products (e.g., two instances of a first air freshener product and two instances of a second different air freshener product). Avatar information can include attributes of the avatar products (e.g., aggregate attributes describing the avatar product as a single entity, similarly to the product attributes). For example avatar information can comprise: identity of one or more products included in the avatar product, aggregate height of the avatar product, aggregate width of the avatar product, aggregate depth of the avatar product, aggregate weight of the avatar product, price of the avatar product, margin of the avatar product, expected sales of the avatar product, and/or number of facings of the avatar product. In a specific embodiment, avatar information comprises:

At 230, one or more objectives are received. In a specific implementation, at least one of profit, revenue, and rank objectives are received. At 240, one or more constraints are received. For example, the constraints can permit a variable number of facings for the products.

At 250, a dynamic model is generated using, at least in part, the one or more objectives 230. The dynamic model uses a hybrid binary multi-dimensional knapsack representation. At 260, an optimization run is performed using the generated dynamic model 250.

At 270, a reverse transform is performed on the output of the optimization run 260. For example, the reverse transform can be used to convert the output of the optimization run into an optimal assortment and an optimal planogram.

At 270, results of the optimization run, which have been reverse transformed, are output. For example, the results can comprise a list or display of an optimal product assortment, where the optimal product assortment is selected from the set of products. The results of the optimization run can also comprise location information (e.g., location of each product on a shelf, such as in the format of a planogram). The results can also comprise, for each of one or more products of the product assortment: a location of the product, and a number of facings for the product.

### Example Product Assortments

In the techniques and solutions described herein, a product assortment can be the result of an optimization process run using a hybrid binary multi-dimensional knapsack representation with an input set of products (e.g., with or without avatar products) from which to select.

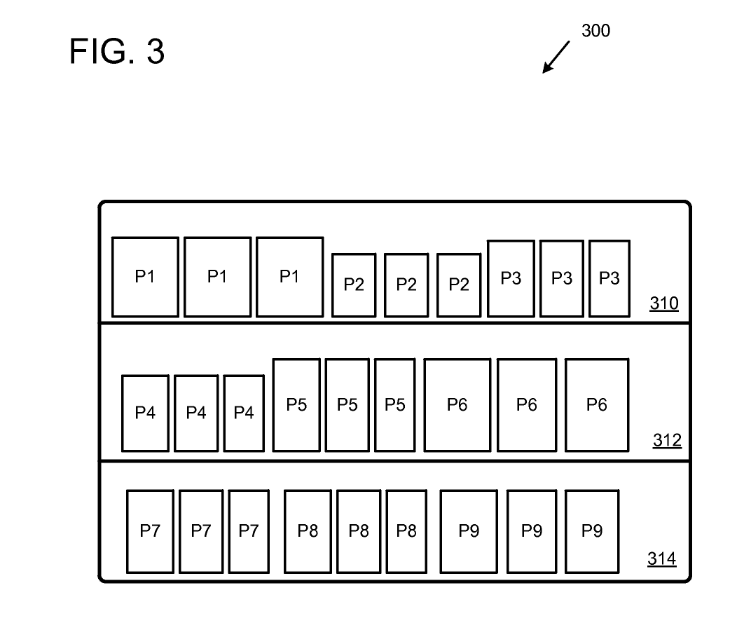

FIG. 3 is a diagram depicting an example planogram 300 representing an optimal product assortment with a fixed number of facings. The example planogram 300 depicts a shelving unit with three shelves 310, 312, and 314. On each shelf, a number of products have been placed. For example, on shelf 310, three instances (three facings) of product “P1” have been placed along with three facings of product “P2” and three facings of product “P3.”

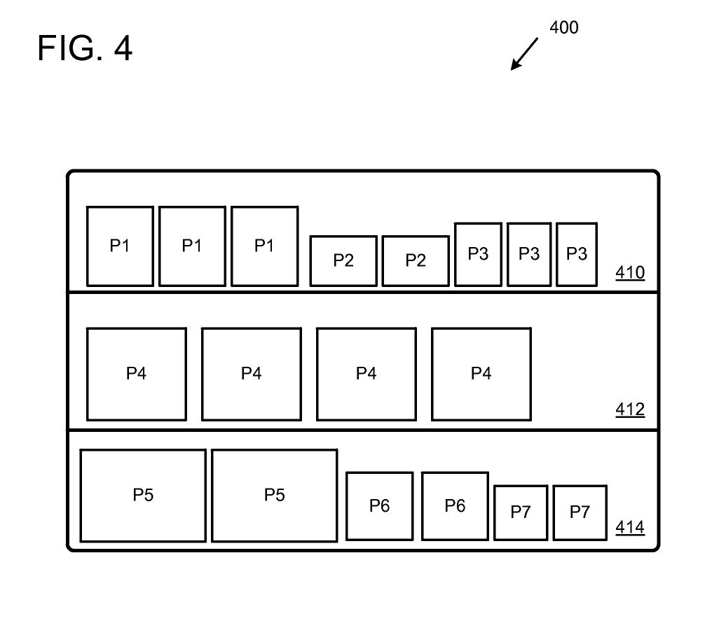

FIG. 4 is a diagram depicting an example planogram 400 representing an optimal product assortment with a variable number of facings. The example planogram 400 depicts a shelving unit with three shelves 410, 412, and 414. On each shelf, a number of products have been placed. For example, on shelf 410, three instances (three facings) of product “P1” have been placed along with two facings of product “P2” and three facings of product “P3.” On shelf 412, four facings of product “P4” have been placed. Allowing the use of a variable number of facings (e.g., from two to four facings) can provide for a more optimal product assortment than using a fixed number of facings (e.g., a higher ROS and/or ROI can be achieved using the same set of input products from which to select products for the assortment).

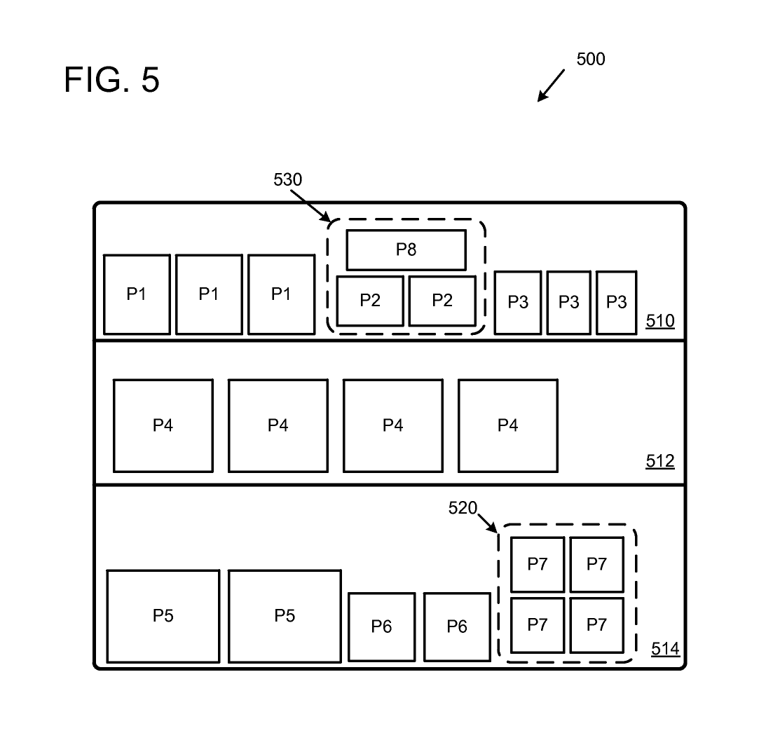

FIG. 5 is a diagram depicting an example planogram 500 representing an optimal product assortment with a variable number of facings, and including avatar products. The example planogram 500 depicts a shelving unit with three shelves 510, 512, and 514. On each shelf, a number of products have been placed. For example, on shelf 510, three instances (three facings) of product “P1” have been placed along with three instances of product “P3.” In addition, an avatar product 530 has been placed on shelf 510. The avatar product 530 includes two instances of product “P2” and one instance of product “P8” that is stacked on top of the product “P2.” The avatar product 530 can also specify location information (e.g., that avatar product 530 must go on the top shelf) and/or rotation information (e.g., which side of products “P2” and/or “P8” will be facing forward). On shelf 512, four facings of product “P4” have been placed. On shelf 514, two instances of product “P5” and two instances of product “P6” have been placed, along with an avatar product 520 with four instances of product “P7” stacked two on top of each other.

### Exemplary Computing Devices

The techniques and solutions described herein can be performed by software and/or hardware of a computing environment, such as a computing device. For example, computing devices include server computers, desktop computers, laptop computers, notebook computers, netbooks, tablet devices, mobile devices, and other types of computing devices. The techniques and solutions described herein can be performed in a cloud computing environment (e.g., comprising virtual machines and underlying infrastructure resources).

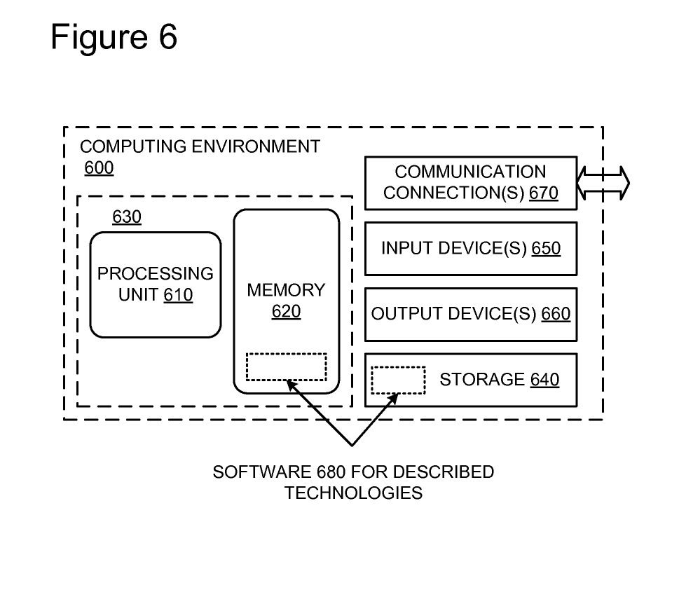

FIG. 6 illustrates a generalized example of a suitable computing environment 600 in which described embodiments, techniques, and technologies may be implemented. The computing environment 600 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like. The disclosed technology may also be practiced in distributed computing environments where tasks are performed by remote processing devices that are linked through a communications network. In a distributed computing environment, program modules may be located in both local and remote memory storage devices.

With reference to FIG. 6, the computing environment 600 includes at least one central processing unit 610 and memory 620. In FIG. 6, this most basic configuration 630 is included within a dashed line. The central processing unit 610 executes computer-executable instructions. In a multi-processing system, multiple processing units execute computer-executable instructions to increase processing power and as such, multiple processors can be running simultaneously. The memory 620 may be volatile memory (e.g., registers, cache, RAM), non-volatile memory (e.g., ROM, EEPROM, flash memory, etc.), or some combination of the two. The memory 620 stores software 680 that can, for example, implement the technologies described herein. A computing environment may have additional features. For example, the computing environment 600 includes storage 640, one or more input devices 650, one or more output devices 660, and one or more communication connections 670. An interconnection mechanism (not shown) such as a bus, a controller, or a network, interconnects the components of the computing environment 600. Typically, operating system software (not shown) provides an operating environment for other software executing in the computing environment 600, and coordinates activities of the components of the computing environment 600.

The storage 640 may be removable or non-removable, and includes magnetic disks, magnetic tapes or cassettes, CD-ROMs, CD-RWs, DVDs, or any other tangible storage medium which can be used to store information and which can be accessed within the computing environment 600. The storage 640 stores instructions for the software 680, which can implement technologies described herein.

The input device(s) 650 may be a touch input device, such as a keyboard, keypad, mouse, pen, or trackball, a voice input device, a scanning device, or another device, that provides input to the computing environment 600. For audio, the input device(s) 650 may be a sound card or similar device that accepts audio input in analog or digital form, or a CD-ROM reader that provides audio samples to the computing environment 600. The output device(s) 660 may be a display, printer, speaker, CD-writer, or another device that provides output from the computing environment 600.

The communication connection(s) 670 enable communication over a communication medium (e.g., a connecting network) to another computing entity. The communication medium conveys information such as computer-executable instructions, compressed graphics information, or other data in a modulated data signal.

### Alternatives and Variations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media (e.g., non-transitory computer-readable media, such as one or more optical media discs such as DVD or CD, volatile memory components (such as DRAM or SRAM), or nonvolatile memory components (such as flash memory or hard drives)) and executed on a computer (e.g., any commercially available computer, including smart phones or other mobile devices that include computing hardware). By way of example and with reference to FIG. 6, computer-readable storage media include memory 620 and/or storage 640. As should be readily understood, the term computer-readable storage media does not include communication connections (e.g., 670) such as modulated data signals.

Any of the computer-executable instructions for implementing the disclosed techniques as well as any data created and used during implementation of the disclosed embodiments can be stored on one or more computer-readable storage media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

The disclosed methods, apparatus, and systems should not be construed as limiting in any way. Instead, the present disclosure is directed toward all novel and non-obvious features and aspects of the various disclosed embodiments, alone and in various combinations and sub-combinations with one another. The disclosed methods, devices, and systems are not limited to any specific aspect or feature or combination thereof, nor do the disclosed embodiments require that any one or more specific advantages be present or problems be solved. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method, implemented at least in part by a computing device, for determining an optimal set of products to be carried for a product assortment and generating an optimal planogram using a hybrid binary multi-dimensional knapsack representation, the method comprising:
receiving one or more objectives;
receiving one or more constraints;
receiving dimensions and hierarchies;
transforming the dimensions and hierarchies into structural graphs of s-cells;
generating a dynamic model using, at least in part, the one or more objectives;
performing an optimization run using the dynamic model; and
outputting results of the optimization run, wherein the results of the optimization run are reverse transformed from the structural graphs of s-cells.

2. The method of claim 1, further comprising:
creating heuristic graphs, wherein the heuristic graphs are used for parallelization.

3. The method of claim 1, further comprising:
generating a set of decisions based, at least in part, on results of the optimization run.

4. The method of claim 1, wherein results of the optimization run comprise:
an optimal set of products selected for the product assortment, wherein the optimal set of products is selected from a list of possible products; and
for each of one or more products of the product assortment, an optimal location for the product.

5. The method of claim 1, wherein the one or more objectives comprises a rank objective.

6. The method of claim 1, wherein the one or more objectives comprises a revenue objective.

7. The method of claim 1, wherein the one or more objectives comprises a profit objective.

8. The method of claim 1, wherein the one or more constraints permit a variable number of facings for the products, and wherein the results of the optimization run comprise the optimal planogram indicating, for each of one or more products of the product assortment:
a location of the product; and
a number of facings for the product.

9. The method of claim 1, wherein the set of products comprises one or more avatar products, wherein each avatar product represents a plurality of products as a single entity.

10. A method, implemented at least in part by a computing device, for determining an optimal product assortment and an optimal planogram, the method comprising:
receiving product attributes for a set of products;
receiving avatar information for the set of products;
receiving one or more objectives;
receiving one or more constraints;
generating a dynamic model using, at least in part, the one or more objectives, wherein the dynamic model uses a hybrid binary multi-dimensional knapsack representation;
performing an optimization run using the dynamic model; and
outputting results of the optimization run, wherein the results comprise an optimal planogram for an optimal product assortment, wherein the optimal product assortment is selected from the set of products.

11. The method of claim 10, wherein the product attributes comprise, for each product of the set of products:
margin;
expected sales;
rank;
number of facings;
dimensions; and
weight.

12. The method of claim 10, wherein the product attributes comprise, for each product of the set of products:
ProductId;
Margin;
Rank;
Effect;
Facings;
ProductWidthInUnits;
ProductHeightInUnits;
MinFacings;
MaxFacings;
Depth;
InventoryOverHead;
ReplenishmentOverHead;
OtherOverHead;
ExpectedSalesUnit;
IsFiller;
ReplenishmentDays;
IsBackRoom;
MinCasePackOnShelf;
MinDisplayUnits;
ProductCasePackSize;
ProductType;
ProductTypeBusiness;
Perishable;
Fragility;
ColorTheme;
StyleTheme;
ProductSize;
ProductWeight;
ProductWeightBearingCapacity;
ProductValue;
SpecialNeeds;
ProductBudget;
UPC;
SKU; and
CategoryId.

13. The method of claim 10, wherein the avatar information comprises, for each of one or more avatar products, which products, of the set of products, are included in the avatar product, and wherein each of the one or more avatar products is optimized as a single entity.

14. The method of claim 10, wherein the avatar information comprises, for each of one or more avatar products:
identity of one or more products, of the set of products, included in the avatar product;
aggregate height;
aggregate width
aggregate depth;
margin of the avatar product;
expected sales of the avatar product; and
number of facings of the avatar product.

15. The method of claim 10, wherein the avatar information comprises, for each of one or more avatar products:
information describing facings for individual products of the avatar product;
information describing stacking for the individual products of the avatar product; and
information describing rotations for the individual products of the avatar product.

16. The method of claim 10, wherein the one or more objectives comprises a rank objective.

17. The method of claim 10, wherein the one or more objectives comprises a revenue objective.

18. The method of claim 10, wherein the one or more objectives comprises a profit objective.

19. The method of claim 10, wherein the one or more constraints permit a variable number of facings for the products, and wherein the results of the optimization run comprise the optimal planogram indicating, for each of one or more products of the product assortment:
a location of the product; and
a number of facings for the product.

20. A system, comprising:
one or more processing units;
memory; and
one or more computer-readable storage media storing computer-executable instructions for causing the system to perform operations comprising:
receiving product attributes for a set of products;
receiving avatar information for the set of products;
receiving one or more objectives;
receiving one or more constraints;
generating a dynamic model using, at least in part, the one or more objectives, wherein the dynamic model uses a hybrid binary multi-dimensional knapsack representation;
performing an optimization run using the dynamic model; and
outputting results of the optimization run, wherein the results comprise an optimal planogram for an optimal product assortment, wherein the optimal product assortment is selected from the set of products.

21. The system of claim 20, wherein the avatar information comprises, for each of one or more avatar products, which products, of the set of products, are included in the avatar product, and wherein each of the one or more avatar products is optimized as a single entity.

22. The system of claim 20, wherein the avatar information comprises, for each of one or more avatar products:
information describing facings for individual products of the avatar product;
information describing stacking for the individual products of the avatar product; and
information describing rotations for the individual products of the avatar product.

23. The system of claim 20, wherein the one or more objectives comprises one or more of a rank objective, a revenue objective, and a profit objective.

24. The system of claim 20, wherein the one or more constraints permit a variable number of facings for the products, and wherein the results of the optimization run comprise the optimal planogram indicating, for each of one or more products of the product assortment:
a location of the product; and
a number of facings for the product.
